(19) United States
(12) Patent Application Publication
(10) Pub. No.: US 2003/0204412 A1
(43) Pub. Date: Oct. 30, 2003

(54) Apparatus and method for providing on-line customized nutrition, fitness, and lifestyle plans based upon a user profile and goals

(76) Inventor: John Brier, Pensacola, FL (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/135,229

(22) Filed: Apr. 29, 2002

(51) Int. Cl. G06F 17/60

(52) U.S. Cl. 705/2

(57) ABSTRACT

An on-line system for generating customized wellness plans tailored to particular users. The system queries the user through an on-line questionnaire in order to obtain a user profile and wellness goals. Based upon that information, the system generates customized individual wellness plans that can include a nutrition plan, a fitness or work-out plan, and a lifestyle plan such as stress-reduction activities. The user records information concerning execution of the plans, and the system continually modifies the user's individual wellness plans based upon the recorded information. The system can also display graphical data or other information to the user to illustrate the user's progress and permit on-line shopping for products or services that can be used in conjunction with the execution of the user's wellness plans.

### FIELD OF THE INVENTION

The present invention relates to a system and method for generating custom wellness plans, including nutrition, fitness, and lifestyle plans, based upon a user profile and goals.

### BACKGROUND OF THE INVENTION

Various programs exist relating to particular aspects of a person's health. For example, one type of program assists a user in developing exercise work-outs either for fitness in general or for a particular sport. These programs provide a series or set work-out routines that the person should follow in order to improve physical conditioning in general or for participation in one of the sports. However, these types of programs generally do not have flexibility to accommodate the various characteristics of each person or allow for time away from the program due to illness, for example. Therefore, the programs usually must be rigidly followed by each person participating in them.

Other health programs relate to nutrition and diet. These programs can each be targeted to a particular nutrition goal, such as losing weight, developing more muscle mass, or increasing energy. As with the exercise programs, these nutrition programs tend to be rigidly structured programs not tailored to any particular individual. In addition, the nutrition programs do not in general take into account the effect of the person's exercise program on his or her nutritional needs.

Still other programs relate to lifestyle such as various stress-reduction programs, including yoga, meditation, or similar programs. Each person, however, must select or experiment with the program that works best. The stress-reduction program does not take into account how its effectiveness can be influenced by a person's exercise or nutrition program and, accordingly, does not consider which program would work best for a particular individual.

Accordingly, a need exists for a program that considers multiple aspects of a person's health or wellness in order to provide customized wellness programs or plans for each person.

### SUMMARY OF THE INVENTION

A method and apparatus consistent with the present invention generate a customized wellness program for a user based upon the user's profile and goals. The user is queried concerning a plurality of wellness topics such as through an on-line questionnaire, and the user provides wellness information such as the user's physical characteristics, wellness history, and goals for the wellness program. Based upon the user's wellness information, a wellness plan is generated for the user, and the wellness plan can include a number of customized plans each directed to a particular wellness aspect for the user, such as nutrition, fitness, and lifestyle plans. The wellness plan can be dynamically modified based upon historical information concerning the user's execution of the plans.

### BRIEF DESCRIPTION OF THE DRAWINGS

FIG. 1A is a diagram conceptually illustrating the generation of customized wellness plans consistent with the present invention.

FIG. 1B is a diagram of an exemplary on-line system for distributing customized wellness plans and related information.

FIGS. 2A and 2B are a flow chart of a routine for generating and distributing customized wellness plans and providing related options.

FIG. 3A is a diagram of a main screen.

FIG. 3B is a diagram of an on-line shopping screen.

FIG. 3C is a diagram of a screen for recording data for use in generating customized wellness plans.

FIG. 3D is a diagram of a screen for displaying historical data concerning a user's execution of customized wellness plans.

FIG. 3E is a diagram of a screen for displaying a next plan among a series of customized wellness plans for a user.

FIG. 3F is a diagram of a screen for receiving a user profile and goals.

### DETAILED DESCRIPTION

### Overview

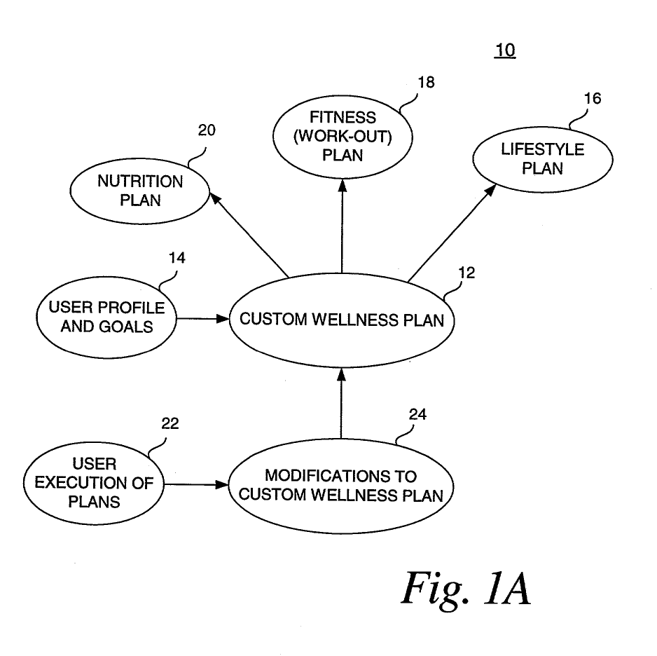

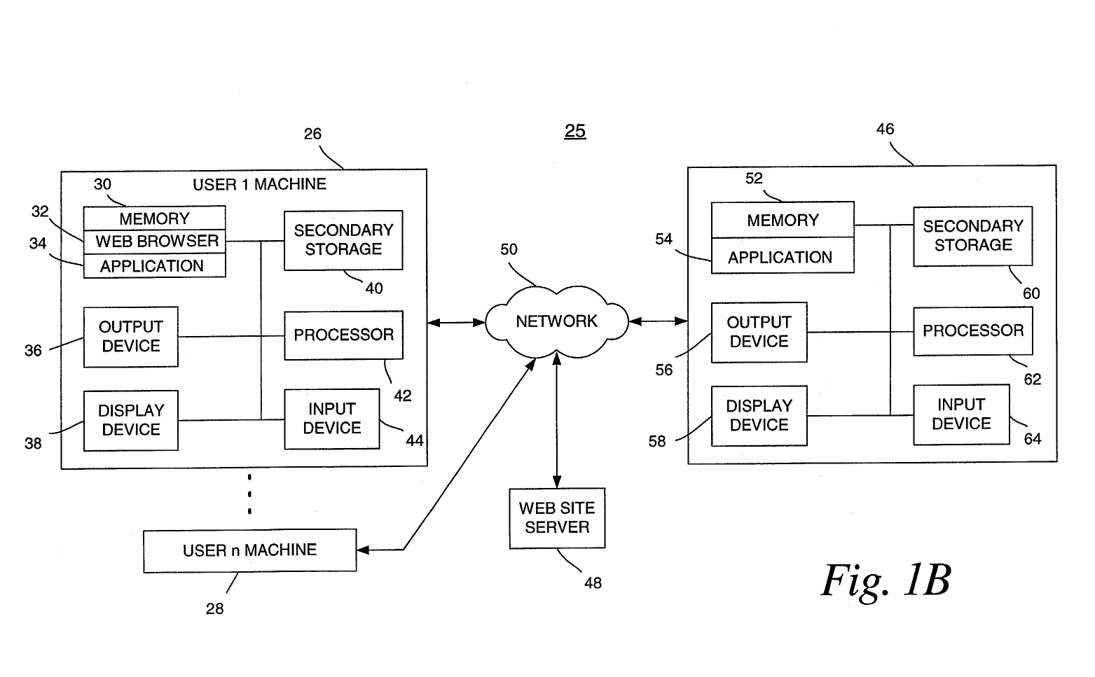

FIG. 1A is a diagram conceptually illustrating a system 10 for the generation of customized wellness plans consistent with the present invention. A user generates a user profile and goals 14. Typically, a user fills out an on-line questionnaire, an example of which is provided below, in order to provide the profile and goals. The profile can include any user-related information and generally contains, for example, information about the user's fitness history, medical history, health-related habits, and physical characteristics. A custom wellness plan 12 is generated for the user based upon the user profile and goals 14. Custom wellness plan 12 typically has a series of related plans, including a custom nutrition plan 20 relating to a preferred diet for the user, a fitness plan 18 relating to work-outs or exercise, and a lifestyle plan 16 for stress-reduction techniques or other such plans.

Each of the individual plans 16, 18, and 20 are related and generated by considering all of them in combination and consistent with the user profile and goals 14. Therefore, the user is provided with individual plans that will cooperatively assist the user in reaching the desired wellness goals. Each of the individual plans are generated, for example, using a computerized methodology as explained below. As the user executes the various plans 22, modifications 24 to the custom plan are generated to continually tailor the nutrition plan 20, fitness plan 18, and lifestyle plan 16 to the user based upon the user's progress. Therefore, the methodology has the flexibility to accommodate a user's individual execution of the plans and the user need not, for example, follow a rigidly set plan.

### Wellness Plan System

FIG. 1B is a diagram of an exemplary on-line system 25 for distributing customized wellness plans and related information. System 25 includes user machines 26 and 28 connected with a network 50 such as the Internet. Users at user machines 26 and 28 interact with a server 46 in order to enter user profiles, goals, and other wellness-related information, and to receive customized wellness plans from server 46, such as nutrition, fitness, and lifestyle plans.

System 25 may also include the ability to access one or more web site servers 48 in order to obtain content from the World Wide Web for use with the customized wellness plans. Only two user machines are shown for illustrative purposes; system 25 may include many user machines and may be scalable to add or delete user machines to or from the network.

User machine 26 illustrates typical components of a user machine. User machine 26 typically includes a memory 30, a secondary storage device 40, a processor 42, an input device 44, a display device 38, and an output device 36. Memory 30 may include random access memory (RAM) or similar types of memory, and it may store one or more applications 34, and a web browser 32, for execution by processor 42. Secondary storage device 40 may include a hard disk drive, floppy disk drive, CD-ROM drive, or other types of non-volatile data storage. Processor 42 may execute applications or programs stored in memory 30 or secondary storage 40, or received from the Internet or other network 50. Input device 44 may include any device for entering information into machine 26, such as a microphone, digital camera, video recorder or camcorder, keyboard, cursor-control device, or touch-screen. Display device 38 may include any type of device for presenting visual information such as, for example, a computer monitor or flat-screen display. Output device 36 may include any type of device for presenting a hard copy of information, such as a printer, and other types of output devices include speakers or any device for providing information in audio form.

Web browser 32 is used to access information for customized wellness plans and display them in web pages, for example. Examples of web browsers include the Netscape Navigator program and the Microsoft Internet Explorer program. Any web browser or other application capable of retrieving content from a network and displaying pages or screens may be used.

Examples of user machines for interacting with the system include personal computers, laptop computers, notebook computers, palm top computers, network computers, or any processor-controlled device capable of executing a web browser or other type of application for interacting with the system.

Server 46 typically includes a memory 52, a secondary storage device 60, a processor 62, an input device 64, a display device 58, and an output device 56. Memory 52 may include random access memory (RAM) or similar types of memory, and it may store one or more applications 54 for execution by processor 62. Secondary storage device 60 may include a hard disk drive, floppy disk drive, CD-ROM drive, or other types of non-volatile data storage. Processor 62 may execute one or more applications or programs stored in memory 52 or secondary storage 60, or received from the Internet or other network 50. Input device 64 may include any device for entering information into server 46, such as a microphone, digital camera, video recorder or camcorder, keyboard, cursor-control device, or touch-screen. Display device 58 may include any type of device for presenting visual information such as, for example, a computer monitor or flat-screen display. Output device 56 may include any type of device for presenting a hard copy of information, such as a printer, and other types of output devices include speakers or any device for providing information in audio form.

Server 46 stores a database structure in secondary storage 60, for example, for storing and maintaining information for customized wellness plans, such as the user profiles, goals, and historical data concerning execution of plans. Any type of data structure can be used, such as a relational database or an object-oriented database.

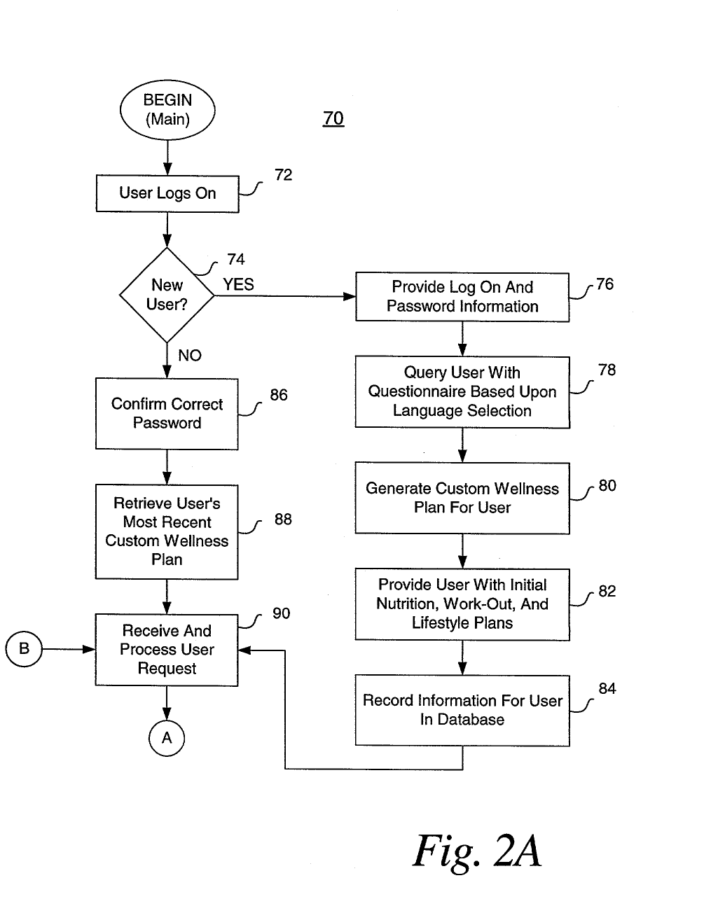

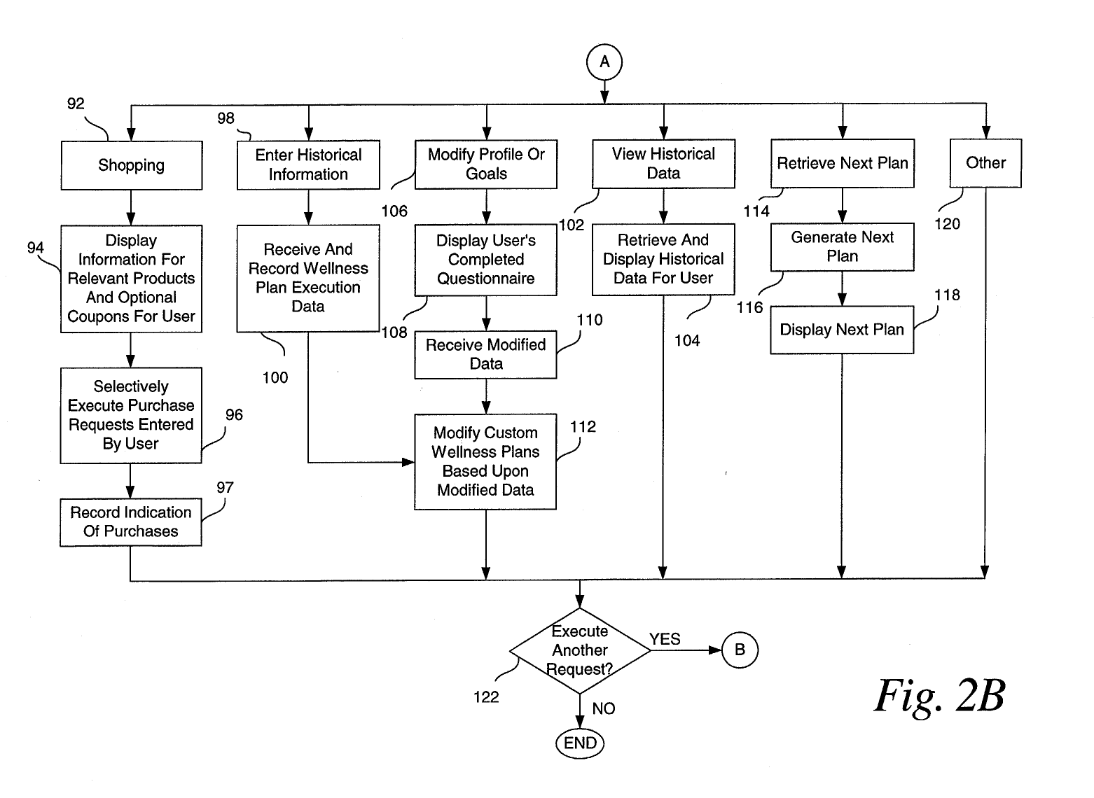

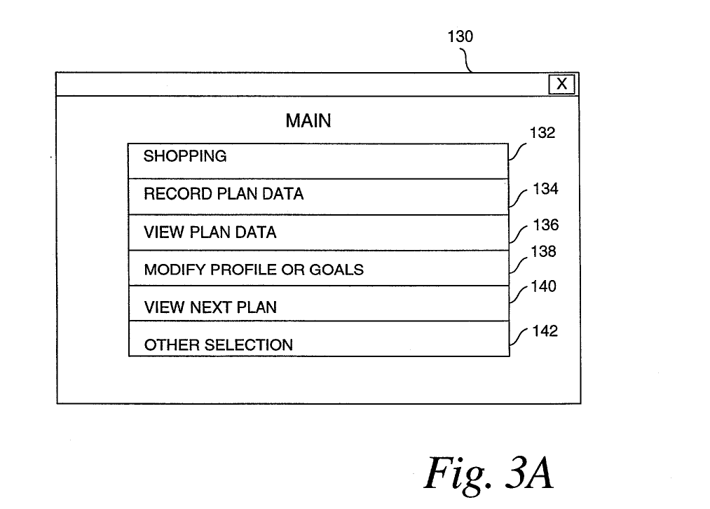

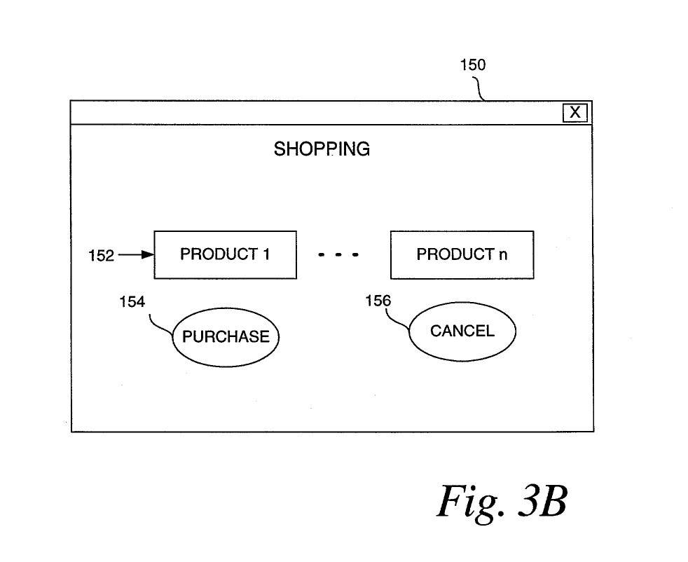

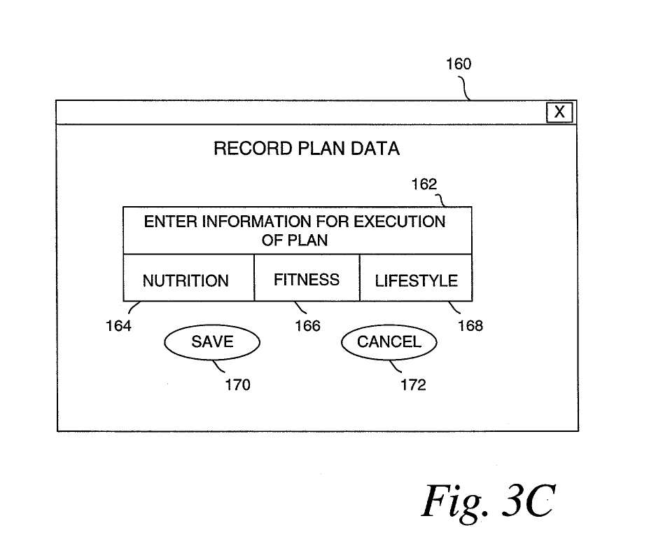

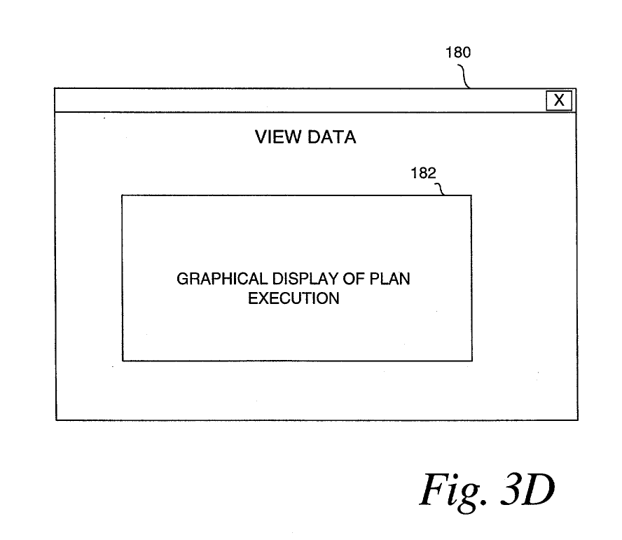

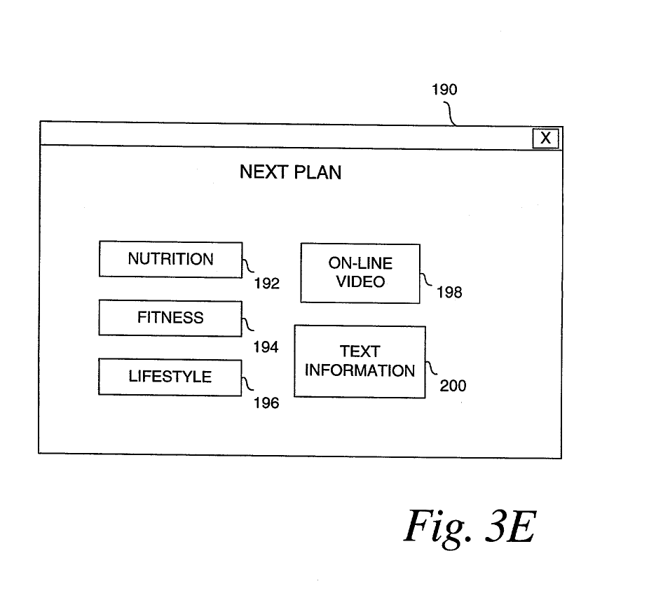

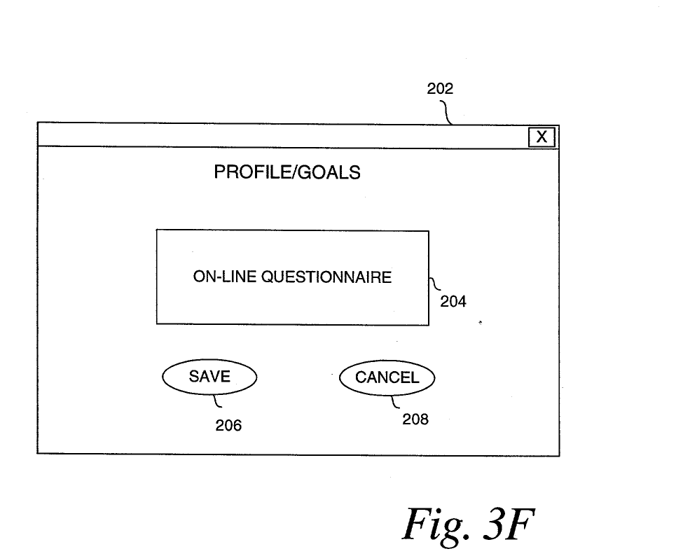

Processor 62 may execute one or more applications 54 in order to provide the functions shown in the flow charts of FIGS. 2A-2B and to provide the web pages shown in the screens of FIGS. 3A-3F.

The screens of FIGS. 3A-3F include various sections, as explained below, to provide information, or to receive information or commands. The term “section” with respect to screens refers to a particular portion of a screen, possibly including the entire screen. Sections are selected, for example, to enter information or commands or to retrieve information or access other screens. The selection may occur, for example, by a using a cursor-control device to “click on” or “double click on” the section; alternatively, sections may be selected by entering a series of key strokes or in other ways such as through voice commands or use of a touch screen. In addition, although the screens shown in FIGS. 3A-3F illustrate a particular arrangement and number of sections in each screen, other arrangements are possible and different numbers of sections in the screens may be used to accomplish the same or similar functions of displaying information and receiving information or commands. Also, the same section may be used for performing a number of functions, such as both displaying information and receiving a command.

Although only one server is shown, system 25 may use multiple servers as necessary or desired to support the users and may also use back-up or redundant servers to prevent network downtime in the event of a failure of a particular server.

Although machine 26 and server 46 are depicted with various components, one skilled in the art will appreciate that this machine and the server can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as machine 26 and server 46, to perform a particular method.

### Wellness Plan Processing

FIGS. 2A and 2B are a flow chart of a routine 70 for generating and distributing customized wellness plans and providing related options. Routine 70 can be implemented, for example, in software modules for execution by user machines 26, 28 and the server 46. In routine 70, a user at a user machine logs onto the system via a browser, for example (step 72). The system can determine whether the user is a new user by, for example, searching a database with the user's name or other identifying information (step 74). If the user does not already have a wellness plan (step 74), the system can initialize the generation of one. The system can provide the user with log-on and password information to provide privacy for the user's stored plan (step 76). The system then queries the user to obtain the user profile and goals (step 78), typically accomplished through an on-line questionnaire and optionally including a language selection to provide the questionnaire in one of multiple languages. The user profile and goals can relate to any aspect of the user's wellness or topics for use in assessing the user's wellness. Examples of these aspects are provided in the exemplary questionnaire below.

FIG. 3F is an example of a screen 202 for display via a browser in order to present the on-line questionnaire. Screen 202 includes a section 204 to present the questionnaire and sections 206 and 208 for the user to save or cancel, respectively, the entered information. The user may also use scroll bars or other browser functions to access the complete questionnaire. Table 1 provides an example of a questionnaire that can be provided on-line through a screen or web page, for example. The form in Table 1 provides exemplary questions for illustrative purposes only and questionnaires consistent with the present invention may include more questions, fewer questions, or different questions. The questions, no matter which ones are used, should illicit information from the user to evaluate the categories of nutrition, fitness, and lifestyle for generation of the custom wellness plan.

Any method of obtaining information for the profile and goals can be used, and it need not occur over the network. For example, the user could provide the information via a telephone call or mail-in form. The system can also provide the option of using multiple languages and can initially query the user concerning a desired language and then provide the questionnaire in that language.

TABLE 1
Enrollement Form (English)

| | |
|---|---|
| 1. | Name |
| 2. | Date of Birth |
| 3. | Address |
| 4. | City |
| 5. | State/Province |
| 6. | Country |
| 7. | Zip/Postal |
| 8. | Telephone |
| 9. | Email address |
| 10. | Sex |
| 11. | How much do you weight currently ? (in pounds or kilos) |
| 12. | Your height (choose either feet or centimeters) |
| 13. | Choose up to 3 sports that you currently participate in. If you don not participate in |
| | any sports skip this question. Your first selection should be the sport you |
| | participate in the most. Your second selection (if any) should be the sport you |
| | participate in the second most. Your third selection (if any) should be the sport you |
| | particpiate in the third most |
| 14. | Have you ever participated in yoga or meditation? |
| 15. | In an average week how often do you participate in cardiovascular activity for 20 |
| | minutes or longer, such as running, walking, biking, aerobics, stairmaster, etc. |
| 16. | If you do currently participate in cardiovascular activity on a regular basis on |
| | average how long to you spend on this activity each time you exercise? If you |
| | answered “none” to the above question you should skip this question. |
| 17. | In the last year what is the longest distance you have walked or ran as part of an |
| | exercise program (answer in either miles or kilometers): |
| 18. | My primary goal is to |
| 19. | What body parts are you intereested in working on the most? Select up to 3 |
| | choices: |
| 20. | In terms of losing fat, I believe I am over or above my ideal weight |
| 21. | In order to reach my goal I need to lose the following amount of weight (choose |
| | either pounds or kilos) |
| 22. | Have you ever joined a gym or fitness club before |
| 23. | I have been a member of a gym or fitness club in the last |
| 24. | I am currently training in a gym or fitness club and have been working out for |
| 25. | I Consider myself |
| 26. | How many times a week do you want to exercise? |
| 27. | How long on average do you want to work out each time you exercise? |
| 28. | Do you spend time stretching before and after you execise? |
| 29. | Do you work out alone or with a partner most of the time? |
| 30. | Does your spouse or significant other exercise regularly? |
| 31. | Do you prefer to have their workout data and program presented in pounds or |
| kilos. | |
| 32. | How flexible would you say you are? |
| 33. | Do you have any injuries that will prohibit certain exercises? |
| 34. | After I eat, I feel weak |
| 35. | My energy drops during the mid morning |
| 36. | I get sick more than twice a year |
| 37. | I find it difficult to concentrate on paper work, and other mental tasks |
| 38. | On some days I feel weak during the following times |
| 39. | On some days I feel depressed during the following times |
| 40. | What do you think your average stress level is on a scale of 1-10 (1-lowest and |
| | 10-highest)? |
| 41. | I feel lonely |
| 42. | Last time when I visited doctor was |
| 43. | Please let us know if you have any of the following health related problems. We |
| | will then be able to suggest diet, workout, and supplement plans that can assist in |
| | alleviating or improving some of these problems. Check the box next to each item |
| | that applies to you: |
| 44. | I use a tanning machine |
| 45. | Do you currently wear glasses or contacts? |
| 46. | How many children do you have? |
| 47. | On average how much sleep do you get each night during the week? |
| 48. | I get hungry in the morning |
| 49. | O get hungry late at night |
| 50. | I eat breakfast daily |
| 51. | I eat the majority of my daily calories after work |
| 52. | I skip meals on a regular basis |
| 53. | I avoid red meat |
| 54. | I eat red meat at least 3 times a week |
| 55. | I eat red meat daily |
| 56. | O avoid bacon |
| 57. | I eat bacon 2 or more times per week |
| 58. | I eat luncheon meats like ham or bologna |
| 59. | I eat luncheon meat daily |
| 60. | I avoid whole eggs |
| 61. | I eat eggs at least 3 times a week |
| 62. | I eat eggs daily |
| 63. | I avoid cheese |
| 64. | I eat cheese at least 3 times a week |
| 65. | I eat cheese daily |
| 66. | I eat non fat cheese |
| 67. | I eat vegetables every day |
| 68. | I eat fruit every day |
| 69. | Water is my favorite beverage |
| 70. | On average I drink the following number of glasses of water per day |
| 71. | Regarding soda and diet soda I usually drink |
| 72. | In an average day how many cans or glasses of soda do you drink? |
| 73. | How many cups of coffee do you drink each day? |
| 74. | How many cups of tea do you drink each day? |
| 75. | If I drink milk I usually drink |
| 76. | How much milk do you drink on an average day? |
| 77. | In an average week how many times fo you eat candy or snack on junk food? |
| 78. | In an average week how many times do you eat at fast food restaurants? |
| 79. | On average I drink alcohol |
| 80. | Do you smoke cigarettes or use any other tobacco products? |
| 81. | My joints sometimes ache |
| 82. | I am interesting in using nutritional supplements to off set potential nutritional |
| | deficiencies |
| 83. | I take vitamins on a daily basis |
| 84. | I am interested in using supplements that may increase strength and muscle size |
| 85. | I am interesting in using herbs, vitamins or powdered drinks to reach my weight |
| | loss goals |
| 86. | I am interesting in using herbs, vitamins or powdered drinks to alter my muscle to |
| | fat ratio |
| 87. | Would you like to take vitamins and nutritional supplements to keep your immune |
| | system and health at peak levels? |
| 88. | Do you have any home exercise videos that you occasionally use to workout at |
| | home? |
| 89. | How many pairs of running or exercise shoes do you have that you currently use |
| | only for working out? |
| 90. | Do you have clothing that you set aside to wear only when you are going to |
| | workout? |
| 91. | In the last 3-years you purchased a piece of exercise equitment for home use? |
| 92. | When grocery shopping do you make a consistent effort to buy products that are |
| | low in fat? |
| 93. | I would like to receive one minute nutrition lesson (e-mailed daily. Gives a tip and |
| | encourages product sale. Example: “Did you know salmon prevents arthritis?”) |
| 94. | In an average week how many hours do you work? Housewives should count time |
| | spent caring for young children, doing housework, etc., as worktime. |

After receiving the new user's information for the profile and goals, the system generates a custom wellness plan for the user (step 80). The generation of a custom wellness plan for step 80 can use any algorithm or methodology that takes into consideration the three factors of nutrition, fitness, and lifestyle, as described with respect to FIG. 1, for each of the individual plans within the custom wellness plan. For example, generating a custom nutrition plan for the user takes into consideration the user's nutrition, fitness, and lifestyle information and possibly goals. Likewise, generation of custom fitness and lifestyle plans takes into consideration the user's nutrition, fitness, and lifestyle information and possibly goals. Therefore, each individual plan is most likely best tailored to the user's wellness information and goals.

Various methodologies exist for accomplishing the generation of the user's custom wellness plan taking into consideration the nutrition, fitness, and lifestyle information and possibly goals. For example, an empirical method may be used that generates the plans based upon a trial-and-error approach. This method may use, for example, an initial plan chosen from a series of default plans that best fits the user's wellness information and possibly goals. The initial plan can then be empirically refined based upon the user's execution of the plan and a determination of which plan changes result in progression toward or away from the goals.

Another exemplary method can use neural network processing techniques with optional weighted variables. For this method, each of the questions in the questionnaire can be represented by a variable, the value of which is related to the user's specific information for that question. Each variable can also be optionally weighted to further refine the processing. For example, different users may wish to focus on a particular aspect of nutrition, fitness, or wellness, and particular variables can be weighted appropriately in order to emphasize that aspect. A neural network software or hardware implementation can process the variables to generate information for the custom wellness plan. The neural network can include, for example, pre-processors to condition or weight the data variables in addition conversion of raw data from the questionnaire answers into suitable variable data for processing. A neural network to generate the custom wellness plans can be implemented with a conventional neural network for processing data; neural networks and technology are known in the art as described, for example, in the following text, incorporated herein by reference: Timothy Masters, “Practical Neural Network Recipes in C++,” pp. 253-341 (Morgan Kaufmann 1993). Examples of neural network products include the following: the BrainMaker Neural Network Software Product by California Scientific Software, Nev. City, Calif.; and the NeuroSolutions product and related products by NeuroDimension, Inc., Gainesville, Fla.

A preferred method may involve an algorithmic approach as follows. The questionnaire can use an algorithm based upon age, body weight, height, and body mass to prescribe an energy (caloric) intake as well as a specific intake of macronutrients, carbohydrates, protein, and dietary fat. The energy intake is used as a base, and this base is subjected to change based upon the user's level of fitness and goals. A software program implementing the algorithm then prescribes rotational training protocols based upon information derived from the user's answers to the questionnaire. The training protocols can be tailored to focus on a particular aspect of fitness, for example. The software also automatically tracks and updates for the user pertinent past and present training data to generate future work out plans; the tracking can be accomplished using, for example, entered data as described with respect to steps 98 and 100. The software also takes into consideration nutritional and lifestyle information as derived from the user's answers to the questionnaire. It may suggest nutritional supplements and herbs, for example, to alleviate nutritional concerns derived from the answers to the questionnaire and also may prescribe lifestyle plans to alleviate general lifestyle concerns such as, for example, low energy, depression, or lifestyle choices that affect heart disease.

The system can also perform various administrative functions such as, for example, setting up an on-line account for the user. The system can also charge the user various fees for providing the wellness plans such as, for example, a monthly fee or a fee for each plan requested by the user. The user may provide, for example, a credit card number and related information in order for the system to charge the fees. It can also save the credit card information for use in executing purchase requests by the user during on-line shopping.

The system provides the user with initial nutrition, fitness, and lifestyle plans (step 82) as generated in step 80. FIG. 3E is a diagram of an exemplary screen 190 for providing a “next” plan or, in this case, the initial plan for the user. Screen 190 can include sections for selection by the user in order to access and view the individual plans, including a section 192 for a nutrition plan, a section 194 for a fitness plan, and a section 196 for a lifestyle plan. The information for each plan can be provided or displayed in a variety of ways. For example, an on-line video 198 can provide information for the plans in video form such as by illustrating how to perform a work-out. A section 200 can present textual information for the plan, such as instructions for exercise, diet, or stress-reduction plans, and it can provide the user with the option to print the plan in hard copy form. Any multimedia, visual, or audio information, or a combination, can be used for providing the individual wellness plans. A nutrition plan includes any information concerning nutritional aspects for the user including, for example, meal plans, vitamins, or supplements. In addition to providing the wellness plan on-line, the system can provide it in other ways such as through e-mail reminders, computer-generated phone calls, or mailings. The information, whether provided on-line or in other ways, can be provided in any form, such as through a recipe to be printed in hard copy form or in a fitness calendar for the user to schedule the work-outs.

A fitness plan includes any information concerning exercise for the user including, for example, work-out routines, types of exercises, number of repetitions of particular exercises, amount of weights for weight training type exercises, or duration of exercises. A lifestyle plan includes any information concerning a user's general lifestyle including, for example, any stress reduction program such as meditation or yoga, ergonomic programs related to improving posture, or programs related to mental health.

The various wellness plans can also be tailored to particular groups, in addition to customizing them to individuals. For example, programs can exist for university athletics or military personnel, and those programs can be individually customized for the university athlete or military person.

The system also records information for the new user in the database (step 84). For example, the system can record an identification of the initial plans for use in generating the next individual wellness plans and thus continue to customize the plans for the user. The system can then permit the user to execute various options, as further explained below for step 90.

Returning to step 74, if the user logging on already has a plan, the system can receive and confirm a password or the security information for the user (step 86). The system can retrieve the user's most recent custom wellness plan (step 88) and provide the user with various options. FIG. 3A is a diagram of an exemplary main screen 130 providing the user with various options. For example, screen 130 includes a section 132 for the user to perform on-line shopping for products or services, a section 134 for the user to record data concerning execution of the user's custom wellness plans, a section 136 for the user to view historical plan data, a section 138 for the user to modify the user profile or goals, a section 140 to view the user's next plan, and optionally a section 142 for other options. Screen 130 is shown conceptually for illustrative purposes, and it may correspond with, for example, a home page for a web site and include various graphics, colors, multimedia information, or on-line advertising.

The system receives a user request through selection of one of the sections in screen 130 (step 90). If the user selects section 132, the system permits the user to engage in on-line shopping for products or services (step 92). The system displays identifications of relevant products or services for the user, and it can select those products and services based at least in part upon the user's profile and goals (step 94). It can also display, for example, on-line coupons, e-gift certificates, or other incentives such as mass e-mail promotions. Upon a user's selection of a product or service, the system can execute a purchase request (step 96) and record an indication of the user's purchased product or service (step 97) for use in, for example, modifying the user's wellness plans. The execution of the purchase request can include processing of entered credit card and shipping information. Software for executing on-line purchases of products and performing associated credit card processing is known in the art.

FIG. 3B is a diagram of an exemplary screen 150 illustrating on-line shopping. Screen 150 can display identifications of various products or services 152, which can include displaying textual, graphical, or multi-media information describing the products or services. The displayed information can also indicate how the products or services fit within the user's wellness plans or can otherwise be used for execution of those plans. Selection of a section 154 permits the user to purchase a product or service, and selection of a section 156 permits the user to cancel the on-line shopping. Screen 150 can include other information, such as various colors, graphics, and advertisements. The user may possibly navigate the screen using conventional browser functions, and the screen can be associated with other screens for executing an on-line purchase such as an on-line order form or shopping basket.

If the user selected section 134 in screen 130, the system permits the user to record information concerning execution of the user's wellness plans (step 98). In particular, the system receives and records wellness plan execution data for the user (step 100). This feedback information can be used as adjustors to the user's wellness plan by generating modified wellness plans based upon it (step 112); the processing for step 112 can use, for example, the same methodology as described with respect to step 80 using the new information from step 100. The information typically relates to the user's execution of the wellness plan and can also include other information such as various time parameters relating to the user's desire to take time off from one or more of the plans or to alter the frequency of execution of the plans.

FIG. 3C is a diagram of an exemplary screen 160 for recording this data. Screen 160 includes a section 162 for the user to enter the data. For example, the user can enter nutrition data in section 164, fitness data in section 166, and lifestyle data in section 168. Each of the sections 164, 166, and 168 can optionally be linked with other pages for permitting the user to enter the information. The other pages can include, for example, on-line forms tailored to the particular type of information to be entered. For the nutrition plan the user may record, for example, an indication of meals and supplements consumed, possibly with dietary information such as the number of calories. For the fitness plan the user may record, for example, the exercises performed and related information such as the duration of the exercise, number of repetitions, and training conditions. For the lifestyle plan the user may record, for example, the type of stress-reduction activities performed and the duration of each. The user may select a section 170 to save the entered information or select a section 172 to cancel the entered information.

If the user selected section 136 in screen 130, the system permits the user to view historical data concerning the user's execution of the wellness plans (step 102). The system retrieves and display the data (step 104), which can be presented in a variety of forms for the user to view, for example, how the user has progressed toward the wellness goals. FIG. 3D is a diagram of an exemplary screen 180 illustrating the display of data in a section 182 concerning the user's execution of the wellness plans. The data can be displayed in charts, graphs, through text, or in other ways. The display is based upon the user's entered information in step 98 concerning execution of the wellness plans. The graphical information may illustrate, for example, how the user has improved the user's diet over time for the nutrition plan, how the user's physical conditioning has improved for the fitness plan, or how the user has improved in using stress-reduction plans. The display of information is illustrated conceptually, as it may be presented in any form based upon the entered information concerning execution of the plans.

If the user selected section 138 in screen 130, the system permits the user to modify the user's profile and goals (step 106). As illustrated with respect to screen 202 in FIG. 3F, the system can retrieve and display the user's completed questionnaire (step 108) and receive modified information as entered by the user in section 204 (step 110). After receiving the modified user profile and goals, the system re-generates custom wellness plans for the user based upon the new information (step 112).

If the user selected section 140 in screen 130, the system generates and provides the user's next plan (step 114). The system generates the next nutrition plan, fitness plan, and lifestyle plan based upon the user's profile and goals, potentially modified, and upon the user's execution of the plans as recorded by the user (step 116). The processing for step 116 can use, for example, the same methodology as described with respect to step 80 using any new information from step 100 or other applicable sources. The system displays the next wellness plans to the user (step 118), which can occur through screen 190 as described above.

The system can also include other options (step 120) depending upon particular implementations, possibly selected through section 142. If the user makes another request (step 122) by, for example, selecting another section in screen 130, the system can return to step 90 to execute the new request.

While the present invention has been described in connection with an exemplary embodiment, it will be understood that many modifications will be readily apparent to those skilled in the art, and this application is intended to cover any adaptations or variations thereof. For example, different labels for the various features, screen sections, methods, and user machines and server may be used without departing from the scope of the invention. This invention should be limited only by the claims and equivalents thereof.

What is claimed is:

1. A method for generating a wellness program for a user, comprising:
querying a user to obtain information related to the user's wellness;
receiving a user profile and wellness goals based upon the querying;
generating a wellness plan for the user based upon the user profile and goals, the wellness plan including a plurality of customized plans each directed to a particular wellness aspect for the user;
recording historical information related to the user's execution of the wellness plan; and
modifying the wellness plan based upon the historical information.

2. The method of claim 1 wherein the querying step includes presenting an on-line questionnaire to the user.

3. The method of claim 1 wherein the generating step includes generating an exercise program and a nutrition program for the user.

4. The method of claim 1 wherein the generating step includes generating a stress-reduction program for the user.

5. The method of claim 1, further comprising presenting to the user products for sale that can be used as part of the wellness plan.

6. The method of claim 5, further comprising receiving from the user a request to purchase one of the products.

7. The method of claim 1, further including presenting a graphical indication of the historical information.

8. The method of claim 1, further including distributing the wellness plan on-line to the user.

9. The method of claim 1 wherein the generating step includes providing on-line individual workout plans for the user.

10. The method of claim 1 wherein the generating step includes providing an on-line exercise video.

11. The method of claim 1 wherein the generating step includes providing on-ine nutritional information.

12. The method of claim 1 wherein the generating step includes generating an iterative series of workout plans for the user.

13. The method of claim 5, further including providing incentives to the user for purchase of at least one of the products.

14. The method of claim 1 wherein the generating step includes accessing a plurality of particular workout plans and matching at least one of the workout plans to the user based upon criteria related to the wellness information.

15. An apparatus for generating a wellness program for a user, comprising:
a query module for querying a user to obtain information related to the user's wellness;
a receive module for receiving a user profile and wellness goals based upon the querying;
a generate module for generating a wellness plan for the user based upon the user profile and goals, the wellness plan including a plurality of customized plans each directed to a particular wellness aspect for the user;
a record module for recording historical information related to the user's execution of the wellness plan; and
a modify module for modifying the wellness plan based upon the historical information.

16. The apparatus of claim 15 wherein the query module includes a module for presenting an on-line questionnaire to the user.

17. The apparatus of claim 15 wherein the generate module includes a module for generating an exercise program and a nutrition program for the user.

18. The apparatus of claim 15 wherein the generate module includes a module for generating a stress-reduction program for the user.

19. The apparatus of claim 15, further comprising a module for presenting to the user products for sale that can be used as part of the wellness plan.

20. The apparatus of claim 19, further comprising a module for receiving from the user a request to purchase one of the products.

21. The apparatus of claim 15, further including a module for presenting a graphical indication of the historical information.

22. The apparatus of claim 15, further including a module for distributing the wellness plan on-line to the user.

23. The apparatus of claim 15 wherein the generate module includes a module for providing on-line individual workout plans for the user.

24. The apparatus of claim 15 wherein the generate module includes a module for providing an on-line exercise video.

25. The apparatus of claim 15 wherein the generate module includes a module for providing on-line nutritional information.

26. The apparatus of claim 15 wherein the generate module includes a module for generating an iterative series of workout plans for the user.

27. The apparatus of claim 19, further including a module for providing incentives to the user for purchase of at least one of the products.

28. The apparatus of claim 15 wherein the generate module includes a module for accessing a plurality of particular workout plans and matching at least one of the workout plans to the user based upon criteria related to the wellness information.
